(19) United States
(12) Patent Application Publication
(10) Pub. No.: US 2011/0258978 A1
(43) Pub. Date: Oct. 27, 2011

(54) Pole mounted fruit-thinning device

(76) Inventor: Lyle Carter, Naches, WA (US)

(21) Appl. No.: 12/799,374

(22) Filed: Apr. 23, 2010

(51) Int. Cl. A01D 46/247

(52) U.S. Cl. 56/339

(57) ABSTRACT

A ‘head’ or cap device, mountable on the end of a pole, for thinning fruit, such as cherries. The head includes a hub that caps or mounts upon the end of the pole. A multiple of tines mount to and extend outward from the hub, approximately perpendicular from the lengthwise axis of the pole. The tines are regularly spaced around and radially project from the perimeter of the hub and include a bend at their midpoints of approximately forty-five degrees, back toward the far end of the pole. The pole mounted head is especially useful in the swift thinning of unripe cherries, by twisting and raking the tines of the device along fruit laden branches. As the tines become clogged with fruit and debris, the head is rotated by the user to expose clean tines and clear raked fruit and debris from between the tines.

### TECHNICAL FIELD

A rake for use as a thinning device, and specifically a pole-mounted head for the selective removal of immature fruits, such as cherries, from trees or bushes.

### BACKGROUND OF THE INVENTION

Growers of fruits are increasingly relying on mechanical thinning devices to reduce their reliance on manual intensive labor methods and systems. However, most mechanical systems rely on expensive and cumbersome machinery, and additionally require skilled laborers to operate, repair and maintain such systems. However, in many modern, higher density growing operations, large tractors cannot navigate within the orchard or grove.

Pre-harvest fruit thinning is one agricultural practice that is universally performed manually, and essentially unchanged over time. One non-manual alternative to manual thinning is the use of chemical thinning agents. While initially regarded as safe and effective, chemical thinners are no longer in favor with most growers and orchardists. Chemical thinners were widely employed with certain but often unpredictable results, and most importantly, their use raised consumer concern about the potential residual effects of these thinning agents, as introduced into the food chain. Forced to revert to time tested manual thinning methods, growers and orchardists could still benefit from an aid to better accomplish the thinning of fruits.

Fruit trees often produce or ‘set’ more fruits than the tree can support or fully develop. Fruits in excessive numbers compete with one another for nutrients and typically end up undersized in full maturity at harvest. This competition for nutrients also adds stress on the tree, making it susceptible to pests, disease and thought damage. Leaving too much fruit on a tree can also lead to limb breakage and semi-annual cycles of fruit bearing for the tree.

Newer varieties of cherries ‘self-pollinate’ without the aid of a pollinator variety interspersed within the orchard. Stella, Sweet Stella, Sandra Rose, Santina, Lapins, Skeena, Sonata, and Staccato are all examples of self pollinating sweet cherry varieties. Self-pollination often results in the heavy ‘setting’ of cherries, and often ‘over-setting.’ Some form of thinning is required with over-setting to achieve an adequately large fruit size.

The thinning of fruits increases the size of remaining fruits, with minimal reduction in tree vigor, which is vital in producing an ultimately harvested fruit that must meet minimum size requirements for primum pricing. Especially in view of mounting costs and seasonal labor shortages, there is a significant need for a fruit thinning method and device that is efficient, cost effective and relatively simple to operate, especially when compared to heavy, automated machinery systems.

The following is a disclosure of the present invention that will be understood by reference to the following detailed description taken in conjunction with the accompanying drawings.

### BRIEF DESCRIPTION OF DRAWINGS

FIG. 1A is a perspective view of a pole-mounted fruit thinning head, used according to an embodiment of the invention;

FIG. 1B is a perspective view of a pole-mounted fruit thinning, used according to an embodiment of the invention;

FIG. 1C is a perspective view of a pole-mounted fruit thinning head, used according to an embodiment of the invention;

FIG. 2 is a perspective view of an end portion of a pole-mounted fruit thinning head, according to an embodiment of the invention;

FIG. 3 is a perspective view of a pole-mounted fruit thinning head, according to an embodiment of the invention;

FIG. 4 is an end view of a pole-mounted fruit thinning head, according to an embodiment of the invention; and

FIG. 5 is a side view of a pole-mounted fruit thinning head, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

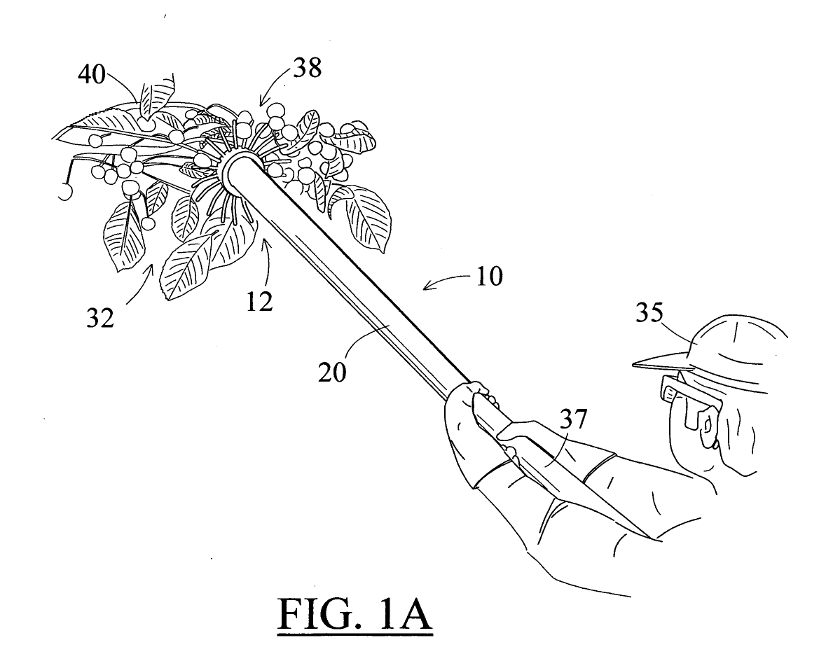

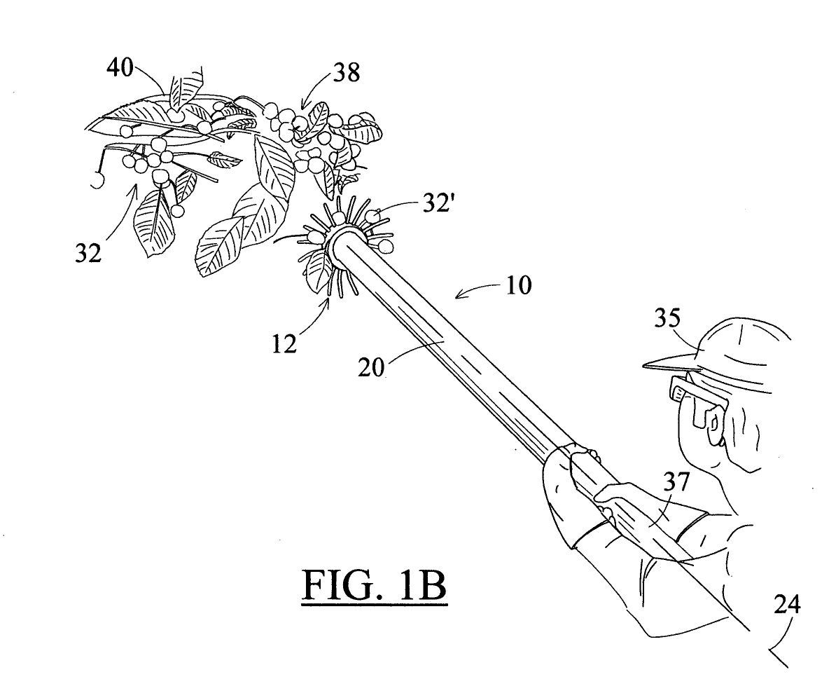

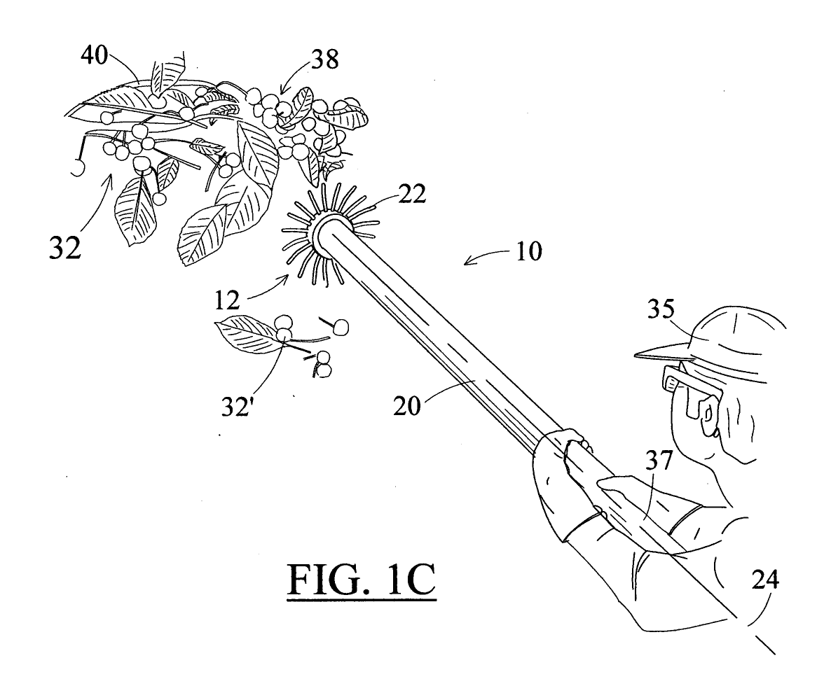

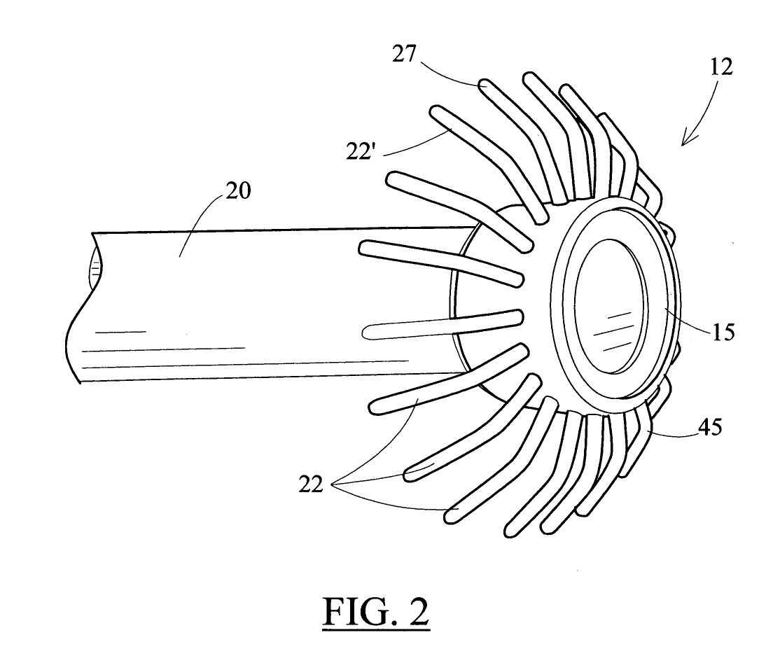

The invention provides a fruit thinning device, mountable to the end of a pole. The fruit thinning device 10 is shown in FIGS. 1A through 5, and may be referred to herein simply as the ‘device.’ The device includes a head 12 with a hub 15 that caps or mounts upon a distal end 17 of the pole 20.

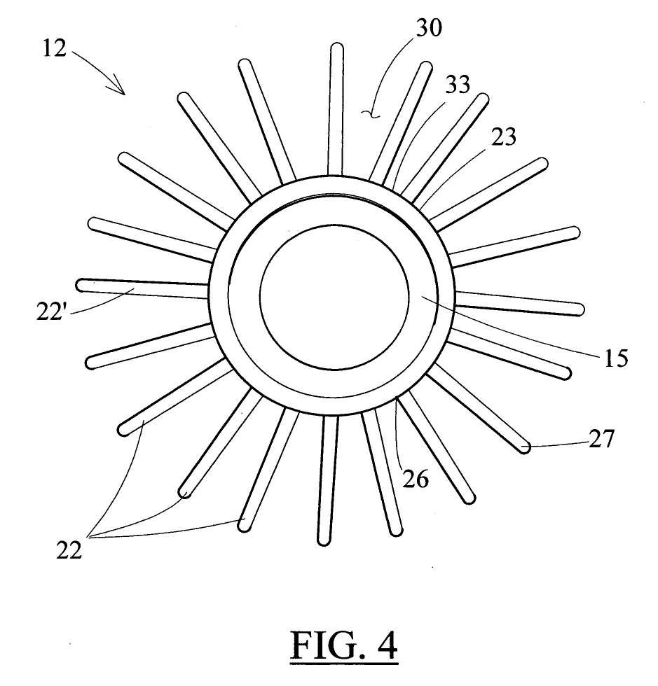

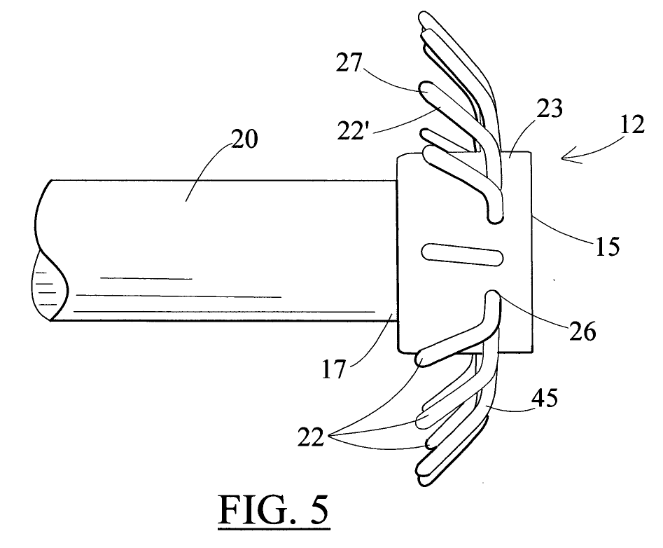

As shown in FIG. 4, a multiple of tines 22 are received into the hub 15 at an outer hub perimeter 23. Each tine 22′ radiates outwardly from the hub perimeter, at approximately a right angle from a lengthwise axis 24 of the pole 20, as shown in FIG. 5.

The terms “approximately” or “approximate” are employed herein throughout, including this detailed description and the attached claims, with the understanding that is denotes a level of exactness as typical for the skill and precision of the applicable field of endeavor.

Preferably, for the multiple of tines 22, approximately twenty tines are evenly spaced around and radially project from the outer hub perimeter 23, of the hub 15. Also preferably, the hub is approximately two inches in diameter, and each tine 22′ is approximately one-eighth inch in thickness and approximately two inches in length, from a tine base 26 to a tine tip 27, as shown in FIGS. 4 and 5. Initially, each tine projects from the hub at a right angle to the lengthwise axis 24 of the pole 20. With this preferred configuration of the multiple of tines about the hub, a triangular space 30 is formed between each neighboring pair of tines, with the hub at an apex 33 of the triangular space, between two neighboring tine bases. This triangular space between the multiple of tines is uniquely able to clutch or grab a fruit 32 at a point proximate to the apex of the triangular space. The head 12 holds the fruit while a user 35, positioned as shown in FIG. 1A and holding the pole 20 near its proximal end 37, can pull upon the pole, in a raking motion as shown in FIG. 1B, to affect removal of the fruit from an attachment point 39 to a branch 40 or limb. It should be noted that the term ‘fruit’ is used herein to describe any cherry fruit-like produce, be it a sweet cherry, a sour cherry, or a hybrid variety.

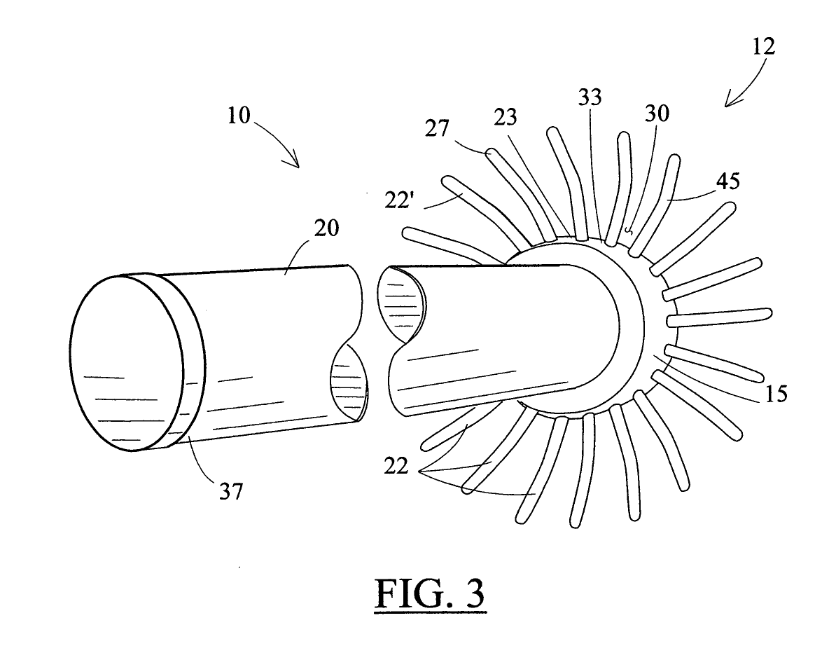

Additionally, as shown in FIG. 5 in a most preferred embodiment of the device 10, each of the multiple of tines 22 includes a midpoint bend 45 of approximately forty-five degrees, so that the tine tip 27 of each tine 22′ is angled toward the proximal end 37 of the pole, as shown in FIG. 3. This midpoint bend facilitates the gathering of the fruit 32 between the tines and ejection of the fruit after the fruit is plucked from the branch 40, as shown in FIG. 1B.

The above described embodiments include features considered critical to the proper operation of the fruit thinning device 10, especially for a most preferred fruit 32, which are a sweet variety of cherries 32′, as shown in FIGS. 1A through 1C. These features include a most preferred, approximately two inch diameter of the hub 15 and equal spacing of the multiple of tines 22, with approximately one-quarter of an inch spacing between neighboring tines 22′ at the apex or tine base 26, and approximately seven-eighths of an inch separating neighboring tines at the tine tip 27.

In a preferred method of using the fruit thinning device 10, it is inserted into a concentration or ‘cluster’ 38 of immature fruit 32, and preferably from an angle that can access the cluster, such as just below the cluster, as shown in FIG. 1A where the cluster is immature cherries 32′. Cherries are typically considered ready for thinning when approximately one-quarter inch to one-half of an inch in size, which is typically reached between three to six weeks after bloom. After grasping the cherries with primarily the upward extending multiple of tines 22, the user then twists the pole 20 about the lengthwise axis 24, to pluck the fruits held between any tines 22′ in a rotating motion, which can be accompanied by a pulling motion on the pole, as shown in FIG. 1B. The head of the device is then further rotated by the user's rotation of the pole 20 placement of the pole by the user, into a neighboring cluster of fruit needing thinning.

As the head 12 is rotated by the user 35, the plucked fruit 32 releases from the grip of the times 22 and the fruit falls out, to the ground below. The tines are thereby cleared for re-use as they are further rotated, re-positioned and re-inserted into a cluster 38, to again engage, twist, rake and pluck additional fruit from the branch 40.

The pole 20 of the fruit thinning device 10 is preferably light in weight, and most preferably be a conventional PVC pipe material of approximately ten feet in length, and with approximately a one and one-quarter inch outside diameter. However, other pole lengths and diameters may be selected as alternatives, based upon the needs of the user, and the size or height of the branches 40 of the trees or bushes requiring thinning by the device.

The user 35 may stand on the ground, below the tree and access the fruit 35 to be thinned with the long pole 20, or the user can use a personal lift to access larger trees with higher limbs that may be difficult to reach, even with the pole, or obscured from sight at ground level. The cluster 38 of immature fruit can be accessed for thinning with the device 10 from any convenient angle. The fruit thinning device of the present invention is much faster and efficient than hand thinning, and substantially eliminates the need for ladders, as typically employed, thereby greatly increasing the speed and safety of fruit thinning operations.

The fruit thinning device 10, is especially suited for the swift thinning of unripe cherries 32′, by the above described twisting and raking motion of the tines 22′ of the device along the fruit laden branches 40. Along with the cherries, a debris 33, which can include leaves and stems, are entrained and removed by action of the tines. The tines may become clogged with fruit and debris, but the head 12 can be rotated, as shown in FIG. 1C, to expose clean tines 22′ to the repeated twisting and raking actions by the user 35. As the clogged tines of the head are rotated, the raked debris clears from between the tines, they are ready to be rotated back into service.

Additionally, to aid in the removal of fruit 32 caught within the tines 22 of the device 10, a cap 48 is preferably place on the proximal end 37 of the pole 20, as shown in FIG. 3. The cap is useful in providing a solid support for ‘rapping’ the device 10 on a surface, such as the ground, to aid in the removal of the cherries 32′ and debris 33 from between neighboring tines 22′ around the hub 15 at the head 12, thereby clearing the tines for reuse after rotation of the pole by the user 35.

The feature of the pie-slice shaped, triangular space 30 between the tines 22′ of the device 10, with the apex 33 of the triangular space near the hub 15, as shown in FIGS. 3 and 4, ensures only a portion of the fruit 32 in any particular cluster 38 is ensnared or grasped with each pass of the head through that cluster. If too many fruits are grasped by the head and pulled or twisted away from the cluster, the entire cluster will be plucked and removed from the branch, which results in undesirable over-thinning. Instead, fruits failing to enter the area of the apex, between the tines are passed-by and left remaining attached to the branch 40, as shown in FIG. 1C. The self-regulating thinning action of the triangular space between tines of the device provides the user with optimal fruit thinning results, without over-thinning.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A fruit thinning device comprising:
a head mountable onto a hand-held pole, the pole having a lengthwise axis;
a multiple of tines radially mounted to the head, the tines extending substantially perpendicularly and away from the lengthwise axis of the pole;
the multiple of tines spaced apart from one another to receive a fruit between tines;
the head includes a hub, the hub for receiving the multiple of tines, and the hub is between one and three inches in diameter, and each tine of the multiple of tines is between one and four inches in length, the tines total between fifteen and twenty-five in number and are evenly spaced about the hub, and each of the multiple of tines have a midpoint; and
each of the multiple of the tines include a bend of an approximately forty-five degree angle located near the midpoint.

2. (canceled)

3. (canceled)

4. The fruit thinning device of claim 1, wherein: the hub is approximately two and one-quarter inches in diameter, and each tine of the multiple of tines is approximately two inches in length; and the tines total approximately twenty in number, and are evenly spaced about the hub.

5. (canceled)

6. A method of a fruit thinning device, the method including the steps of:
a) inserting a head of the device into a cluster of fruit;
b) grasping the fruit within the cluster of fruit with the head, the head including a multiple of tines, the multiple of tines extend radially from and mounted to the head, the head mountable to a pole, and each of the multiple of tines extending substantially perpendicular to a lengthwise axis of the pole, the head including a hub, the hub for receiving the multiple of tines, and the hub is between one and three inches in diameter, and each tine of the multiple of tines is between one and four inches in length, the tines total between fifteen and twenty-five in number and are evenly spaced about the hub, and each of the multiple of tines have a midpoint; and
each of the multiple of the tines include a bend of an approximately forty-five degree angle located near the midpoint;
c) twisting the pole by rotating the head of the device, by a user's rotation of the pole, about the lengthwise axis of the pole; and
d) plucking from the fruit cluster, the fruits held between any of the multiple of tines.

7. The method of the fruit thinning device of claim 6, wherein the step of twisting the pole additionally including the step of pulling with a raking motion.

8. The method of the fruit thinning device of claim 6, additionally including the steps of:
e) releasing the fruits held between any of the multiple of tines;
f) further rotating the head of the device, by the user's rotation of the pole, about the lengthwise axis of the pole; and
g) re-inserting the head of the device into the cluster of fruit.

9. The method of the fruit thinning device of claim 8, wherein the step of twisting the head of the device about the lengthwise axis of the pole, additionally includes the step of rotating the pole by the user's rotation of the pole.

10. The method of the fruit thinning device of claim 8, wherein the step of further rotating the head of the device about the lengthwise axis of the pole, additionally includes the step of pulling the pole from the cluster.

11. A method of a cherry thinning device, the method including the steps of:
a) inserting a head of the device into a cluster of cherries, the head including a multiple of tines, the multiple of tines extend radially from and mounted to the head, the head mountable to a pole, and each of the multiple of tines extending substantially perpendicular to a lengthwise axis of the pole, the head including a hub, the hub for receiving the multiple of tines, and the hub is between one and three inches in diameter, and each tine of the multiple of tines is between one and four inches in length, the tines total between fifteen and twenty-five in number and are evenly spaced about the hub, and each of the multiple of tines have a midpoint; and each of the multiple of the tines include a bend of an approximately forty-five degree angle located near the midpoint;
b) grasping cherries within the cluster of cherries with the multiple of tines;
c) pulling back on the pole; and
d) plucking cherries from the cluster of cherries, the cherries held between any of the multiple of tines.

12. The method of the cherry thinning device of claim 11, wherein the step of pulling back on the pole, additionally includes the step of pulling with a raking motion.

13. The method of the cherry thinning device of claim 11, additionally including the steps of:
e) rotating the head of the device about the lengthwise axis of the pole;
f) releasing the cherries held between any of the multiple of times;
g) further rotating the head of the device about the lengthwise axis of the pole; and
h) re-inserting the head of the device into the cluster of cherries.

14. The method of the cherry thinning device of claim 13, wherein the step of rotating the head of the device about the lengthwise axis of the pole, additionally includes the step of rotating the pole by the user's rotation of the pole.

15. The method of the cherry thinning device of claim 13, wherein the step of further rotating the head of the device about the lengthwise axis of the pole, additionally includes the step of further rotating the pole by the user's further rotation of the pole.
